(19) United States
(12) Patent Application Publication
(10) Pub. No.: US 2026/0257281 A1
(43) Pub. Date: Sep. 3, 2026

(54) BORING TOOL AND METHOD FOR MANUFACTURING MACHINED PRODUCT

(71) Applicant: KYOCERA CORPORATION, Kyoto (JP)

(72) Inventors: Shosei GOTO, Kyoto (JP); Kyosuke TSUCHIGAMI, Kyoto (JP)

(21) Appl. No.: 18/846,655

(22) PCT Filed: Mar. 8, 2023
(86) PCT No.: PCT/JP2023/008800

§ 371 Date: Sep. 13, 2024

(30) Foreign Application Priority Data
Mar. 16, 2022 (JP) 2022-041731

(51) Int. Cl. B23B 29/034

(52) U.S. Cl. CPC B23B 29/034

(57) ABSTRACT

A boring tool may include a shaft member and a first cutter, a third cutter, and a second cutter fixed to the shaft member. A distance between the first cutter and the third cutter may be greater than a distance between the second cutter and the third cutter. The second cutter may have a second front end surface, a second cutting edge located on an outer peripheral side, and a second pocket. The third cutter may have a third front end surface, a third cutting edge located on the outer peripheral side, and a third pocket. The second pocket may be connected to the second front end surface at a right angle, and the third pocket may be connected to the third front end surface at an obtuse angle.

### CROSS-REFERENCE TO RELATED APPLICATIONS

This application is national stage application of International Application No. PCT/JP2023/008800, filed on Mar. 8, 2023, which claims priority to Japanese Patent Application No. 2022-041731, filed on Mar. 16, 2022.

### TECHNICAL FIELD

The present disclosure relates to a boring tool and a method for manufacturing a machined product.

### BACKGROUND OF INVENTION

In general, a boring tool is used for, for example, inner diameter machining (boring) of enlarging an inner diameter by cutting an inner peripheral surface of a cylindrical workpiece. For example, Patent Documents 1 to 3 describe a boring tool including a cylindrical shaft member and a cutting edge fixed such that an edge tip protrudes toward an outer peripheral side from an outer peripheral surface of the shaft member.

### CITATION LIST

### Patent Literature

Patent Document 1: JP 2014-069286 A

Patent Document 2: WO 2015/170390

Patent Document 3: WO 2020/208069

### SUMMARY

A non-limiting example of a boring tool according to the present disclosure includes: a shaft member extending along a rotation axis from a front end toward a rear end; a first cutter located on a side at which the front end is disposed, and fixed to the shaft member; a second cutter located on a side at which the rear end is disposed, and fixed to the shaft member; and a third cutter located between the first cutter and the second cutter and fixed to the shaft member. A distance between the first cutter and the third cutter is greater than a distance between the second cutter and the third cutter. The second cutter includes a second front end surface that is flat and located on the side at which the front end is disposed, a second cutting edge located on an outer peripheral side, and a second pocket located forward of the second cutting edge in a rotation direction of the rotation axis and connected to the second front end surface. The third cutter includes a third front end surface that is flat and located on the side at which the front end is disposed, a third cutting edge located on the outer peripheral side, and a third pocket located forward of the third cutting edge in the rotation direction and connected to the third front end surface. The second pocket is connected to the second front end surface at a right angle, and the third pocket is connected to the third front end surface at an obtuse angle.

### BRIEF DESCRIPTION OF THE DRAWINGS

FIG. 1 is a perspective view illustrating a boring tool of a non-limiting embodiment of the present disclosure.

FIG. 2 is a perspective view of the boring tool illustrated in FIG. 1 as viewed at a different angle.

FIG. 3 is a front view of the boring tool illustrated in FIG. 2 as viewed from a front end side.

FIG. 4 is a side view of the boring tool illustrated in FIG. 1 as viewed in an Al direction in FIG. 3.

FIG. 5 is a side view of the boring tool illustrated in FIG. 1 as viewed in an A2 direction in FIG. 3.

FIG. 6 is a cross-sectional view taken along line VI-VI in FIG. 4.

FIG. 7 is a cross-sectional view taken along line VII-VII in FIG. 4.

FIG. 8 is a cross-sectional view taken along line VIII-VIII in FIG. 5.

FIG. 9 is a cross-sectional view taken along line IX-IX in FIG. 4.

FIG. 10 is a cross-sectional view taken along line X-X in FIG. 5.

FIG. 11 is a schematic diagram illustrating a step of a method for manufacturing a machined product of a non-limiting embodiment of the present disclosure.

FIG. 12 is a schematic diagram illustrating a step of the method for manufacturing the machined product of the non-limiting embodiment of the present disclosure.

FIG. 13 is a schematic diagram illustrating a step of the method for manufacturing the machined product of the non-limiting embodiment of the present disclosure.

FIG. 14 is a schematic diagram illustrating a step of the method for manufacturing the machined product of the non-limiting embodiment of the present disclosure.

### DESCRIPTION OF EMBODIMENTS

Detailed description will be given below of a boring tool, and a method for manufacturing a machined product of an embodiment that is an example of the present disclosure with reference to the diagrams. However, each of the figures, which will be referred to below, is a simplified representation of only main members necessary for description of the embodiment. Accordingly, the rotary tool may be provided with any constituent member that is not illustrated in each of the drawings, which will be referred to. The dimensions of the members in each of the drawings do not faithfully represent the actual dimensions of the constituent members, the dimension ratios of the respective members, or the like.

### Schematic Configuration of Boring Tool

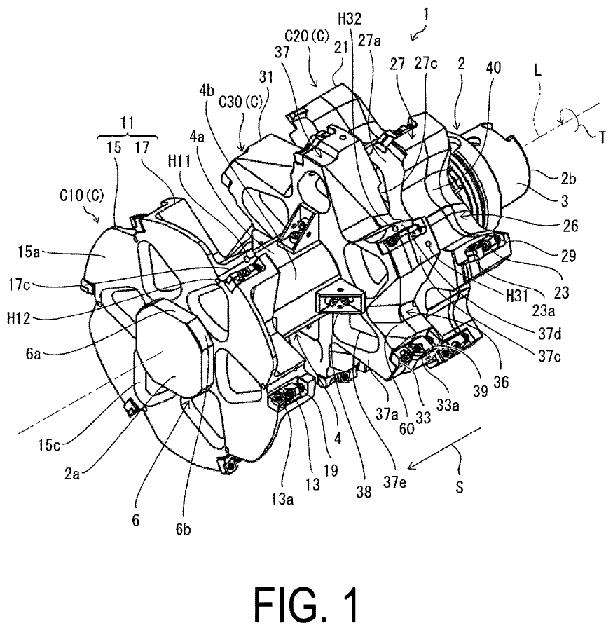

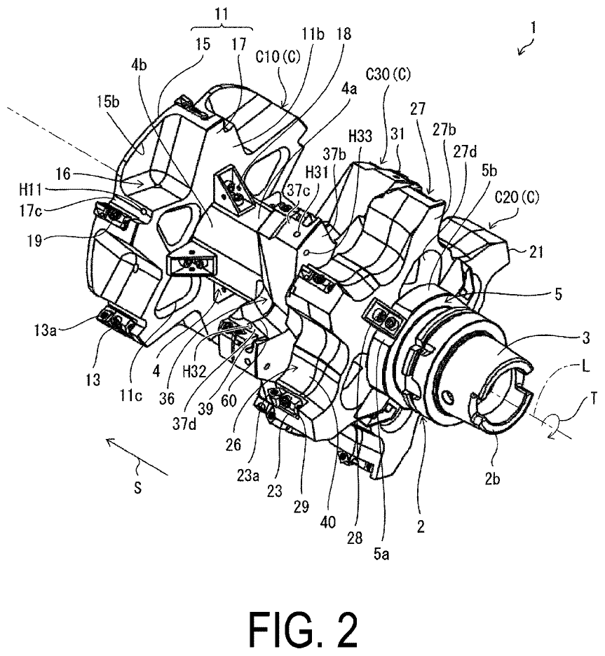

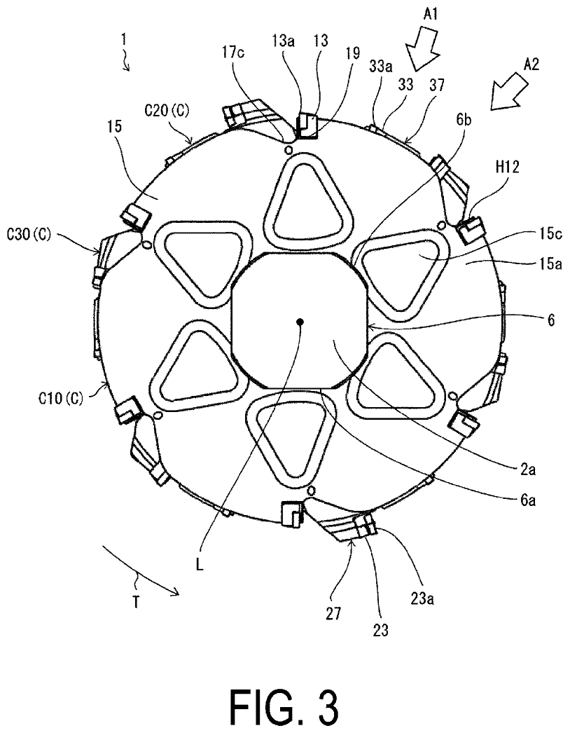

A schematic configuration of a boring tool 1 according to the present embodiment will be described using FIGS. 1 to 3. FIG. 1 is a perspective view illustrating the boring tool 1 of the present embodiment. FIG. 2 is a perspective view of the boring tool 1 as viewed at a different angle. FIG. 3 is a front view of the boring tool 1 illustrated in FIG. 2 as viewed from a front end side. FIG. 2 illustrates a perspective view of the boring tool 1 viewed from another angle with respect to FIG. 1 so that a direction in which a rotation axis L extends is different, in which the boring tool 1 is in a state rotated by 90° about the rotation axis L from the state shown in FIG. 1. The rotation axis L is a rotation axis center of the boring tool 1.

The boring tool 1 according to the present embodiment may include a plurality of cutters. The plurality of cutters may have machining diameters different from each other, respectively. The boring tool 1 may be used for, for example, inner diameter machining of enlarging an inner diameter by cutting an inner peripheral surface of a cylindrical workpiece WP (see FIG. 11 and the like).

The boring tool 1 may be used for inner diameter machining of a housing (case) or the like of an electric motor, for example. In this case, a plurality of machined regions having inner diameters different from each other can be formed on the inner peripheral surface of the workpiece WP in correspondence with the machining diameters of the plurality of cutters. The boring tool 1 may be used for rough boring or fine boring. Further, the boring tool 1 may be used for enlarging a diameter of a prepared hole in the workpiece WP. The prepared hole may be a through hole or a blind hole.

As in the example illustrated in FIG. 1 to FIG. 3, the boring tool 1 may include a shaft member 2 extending along the rotation axis L from a front end (first end) 2a toward a rear end (second end) 2b. The boring tool 1 may have a connecting portion 3 that can be attached, for example, to a spindle (not illustrated) of a machine tool. The boring tool 1 may be attached, for example, to the spindle so as to be rotatable around the rotation axis L. The connecting portion 3 may be a part of the shaft member 2, or may be a member attached to the shaft member 2 and separate from the shaft member 2.

In the boring tool 1 according to the present embodiment, a side on which the connecting portion 3 is located is referred to as the rear end 2b side, and a side opposite to the rear end 2b and in a feed direction of the boring tool 1 (a machining direction with respect to the workpiece WP) is referred to as the front end 2a side. In FIG. 1 and the like, a rotation direction of the boring tool 1 is indicated by an arrow T, and the feed direction (machining direction) of the boring tool 1 during boring is indicated by an arrow S.

Hereinafter, in the present specification, in a cross section including the rotation axis L, a direction orthogonal to the rotation axis L may be referred to as a radial direction, a direction away from the rotation axis L may be referred to as an outer peripheral side (radially outer side), and a direction approaching the rotation axis L may be referred to as an axis center side (radially inner side). Further, a rotation direction about the rotation axis L may be referred to as a circumferential direction.

Here, each part of the boring tool 1 may have rotational symmetry around the rotation axis L. Thus, in the drawings, for clarity of illustration, the same reference numeral may be omitted from each of a plurality of members having similar shapes and functions, and only one of such members may be provided with a reference numeral.

### Shaft Member

The shaft member 2 may include a ring-shaped rear-side fixing portion 5 located closer to the front end 2a side than the connecting portion 3, a flat plate-shaped front-side fixing portion 6 located closer to the front end 2a side than the rear-side fixing portion 5, and a base portion 4 located between the rear-side fixing portion 5 and the front-side fixing portion 6.

The rear-side fixing portion 5 may be a part of the shaft member 2, or may be a member attached to an outer surface of the shaft member 2 and separate from the shaft member 2. The rear-side fixing portion 5 may have a larger size in the radial direction than the base portion 4. The rear-side fixing portion 5 may have an external shape formed by performing a process of forming a plane on four sides in the radial direction with respect to an annular ring. The rear-side fixing portion 5 may have, on a surface on the outer peripheral side, four flat surfaces 5a located on four sides in the radial direction and four curved surfaces 5b located between the four flat surfaces 5a and having a protruding shape on the outer peripheral side.

The front-side fixing portion 6 may be a part of the shaft member 2, or may be a member attached to the front end 2a side of the shaft member 2 and separate from the shaft member 2. The front-side fixing portion 6 may have a larger size in the radial direction than the base portion 4. The front-side fixing portion 6 may have an external shape formed by rounding four corners of a quadrangular flat plate. The front-side fixing portion 6 may have, on a surface on the outer peripheral side, four flat surfaces 6a located on four sides in the radial direction and four curved surfaces 6b located between the four flat surfaces 6a and having a protruding shape on the outer peripheral side.

A plurality of cutters C are attached to the base portion 4. The plurality of cutters C may be fixed at positions of the base portion 4 different from each other in a direction in which the rotation axis L extends (a longitudinal direction of the base portion 4). The base portion 4 may have an external shape formed by rounding four corners of a rectangular parallelepiped, for example. The base portion 4 may have four flat surfaces 4a located on four sides in the radial direction and four curved surfaces 4b located between the four flat surfaces 4a and having a protruding shape on the outer peripheral side.

A coolant flow channel may be formed inside the base portion 4, and the flow channel may communicate with a coolant flow channel formed inside each of the plurality of cutters C attached to the base portion 4. The coolant may be, for example, air or a liquid.

Examples of the liquid coolant include water-insoluble oil agents, or water-soluble oil agents such as emulsion-based, soluble-based, and solution-based cutting oils.

In the present embodiment, in a positional relationship in the circumferential direction, a position of the flat surface 5a of the rear-side fixing portion 5 and a position of the curved surface 4b of the base portion 4 may correspond to each other, and a position of the curved surface 5b of the rear-side fixing portion 5 and a position of the flat surface 4a of the base portion 4 may correspond to each other. In addition, in the present embodiment, in the circumferential direction, a position of the flat surface 6a of the front-side fixing portion 6 and the position of the flat surface 4a of the base portion 4 may correspond to each other, and a position of the curved surface 6b of the front-side fixing portion 6 and the position of the curved surface 4b of the base portion 4 may correspond to each other.

### Cutter

The boring tool 1 may include a first cutter C10, a second cutter C20, and a third cutter C30, as the plurality of cutters C. In the present specification, if the first to third cutters C10 to C30 are not distinguished from each other, they may be collectively referred to as a cutter C.

### First Cutter

The first cutter C10 may be located on the front end 2a side and fixed to the shaft member 2. The first cutter C10 may include a first cutter body 11 and a first cartridge 13 as a cutting edge (first cutting edge) located on the outer peripheral side. The first cutter body 11 may have a plate-shaped front end plate portion 15 and a plurality of first protruding portions 17 formed so as to rise from the front end plate portion 15 toward the rear end 2b side and provided so as to protrude in the radial direction. The first protruding portion 17 may have a first pedestal portion 19 to which the first cartridge 13 is attached at an end portion on the outer peripheral side.

The first cutter body 11 may have a center hole through which the base portion 4 can be inserted. The first cutter body 11 may have, for example, a plate shape. Specifically, the first cutter body may have a three-dimensional shape, in which the front end plate portion 15 and the plurality of first protruding portions 17 are formed, by digging and removing part of a disk-shaped object having an annular shape in a cross-sectional view taken in a direction orthogonal to the rotation axis L.

In the present embodiment, the first cutter body 11 may have six first protruding portions 17 protruding in six directions in the radial direction. The front end plate portion 15 and the first protruding portions 17 of the first cutter body 11 may be integrally formed so as to be continuous with each other. In the present embodiment, the center hole of the first cutter body 11 corresponds to the shape of the base portion 4 (a substantially octagonal shape in a cross-sectional view taken in a direction orthogonal to the rotation axis L), so that the first cutter body 11 may have a shape of two-fold symmetry around the rotation axis L.

The front end plate portion 15 may have a front plate surface 15a on the front end 2a side and a back plate surface 15b on the rear end 2b side. The first cutter body 11 may have, between two adjacent first protruding portions 17, a recessed portion 16 that is a space partially surrounded by side surfaces of the two first protruding portions 17 and the back plate surface 15b. The recessed portion 16 may be isolated from the front end 2a side by the front end plate portion 15 located on the front end 2a side. Thus, if the workpiece WP is subjected to boring by the boring tool 1, the front end 2a side and the rear end 2b side of a hole to be machined may be blocked therebetween by the front end plate portion 15.

Chips in the boring tool 1 flow together with the coolant from the front end 2a side toward the rear end 2b side. The recessed portion 16 may be a chip pocket through which some of the chips generated by the cutting edge of the first cartridge 13 pass.

The first protruding portion 17 may have a first outer peripheral surface 17c on the outer peripheral side. The first outer peripheral surface 17c may be located forward of the first pedestal portion 19 in the rotation direction T and may be located side by side with the first pedestal portion 19. The first outer peripheral surface 17c may be a surface that is located inward of the first pedestal portion 19 in the radial direction and formed at a position lower than the first pedestal portion 19 in the radial direction. A coolant ejection hole H11 may be formed in the first outer peripheral surface 17c. Note that the coolant ejection hole H11 may be formed in the recessed portion 16 in addition to the first outer peripheral surface 17c.

The ejection hole H11 may be located closer to the rear end 2b side than the first pedestal portion 19. In addition, a coolant ejection hole H12 may be formed in the front plate surface 15a at a position in the vicinity of the first outer peripheral surface 17c. The coolant ejected from the ejection hole H12 passes through a part of the first outer peripheral surface 17c, comes into contact with the cutting edge of the first cartridge 13, and flows toward the rear end 2b side. The coolant ejected from the ejection hole H11 flows toward the rear end 2b side together with the coolant ejected from the ejection hole H12.

The first cutter C10 only needs to have a cutting edge (first cutting edge) whose edge tip protrudes from the outer peripheral surface of the first cutter body 11, and a specific aspect of the cutting edge located on the outer peripheral side is not particularly limited. In the present embodiment, one first cartridge 13 may be attached to the first pedestal portion 19 of each of the six first protruding portions 17 by a clamp screw or the like. As the first cartridge 13, a known cartridge can be used, and a specific aspect of the first cartridge 13 is not particularly limited.

A first insert (first cutting edge) 13a may be attached to the first cartridge 13 by a screw or the like. The first insert 13a is a so-called cutting insert. A specific aspect of the first insert 13a is not particularly limited. The position of at least one of the first cartridge 13 and the first insert 13a may be adjustable in the radial direction. Thus, a machining diameter by the first cutter C10 can be adjusted.

A surface of the first cutter body 11 on the rear end 2b side is referred to as a first rear-side surface 11b. The first rear-side surface 11b may be a surface of the first protruding portion 17 on the rear end 2b side. The first cutter C10 may be fixed to the shaft member 2 as follows. That is, the first cutter C10 may be fixed to the shaft member 2 by screwing the first rear-side surface 11b and the flat surface 4a of the base portion 4 using a first fixture 18. In other words, the first cutter C10 may be fixed to the shaft member 2 by the first fixture 18 located closer to the rear end 2b side than the first cutter body 11. In the first cutter C10, part of the front plate surface 15a of the front end plate portion 15 may be in contact with the front-side fixing portion 6.

The first cutter body 11 may be subjected to a lightening process for weight reduction or the like, and may have a plurality of recessed portions 15c formed in the front plate surface 15a of the front end plate portion 15. The recessed portion 15c may have a rounded triangular shape in a view from a direction along the rotation axis L. The recessed portion 15c may be formed at a position corresponding to the front end 2a side of the first protruding portion 17 in a plane perspective view from the front end 2a side toward the rear end 2b side. In addition, the first cutter body 11 may have a plurality of recessed portions 11c formed in the first rear-side surface 11b. The recessed portion 11c may have a rounded triangular shape in a view from the direction along the rotation axis L. The recessed portion 11c may be formed so as to avoid a region of the first rear-side surface 11b to which the first fixture 18 is screwed.

### Second Cutter

The second cutter C20 may be located on the rear end 2b side and fixed to the shaft member 2. The second cutter C20 may include a second cutter body 21 and a second cartridge 23 as a cutting edge (second cutting edge) located on the outer peripheral side. The second cutter body 21 may have a second protruding portion 27 provided to protrude in the radial direction. The second protruding portion 27 may have a second pedestal portion 29 to which the second cartridge 23 is attached at an end portion on the outer peripheral side. The second cutter C20 may have a second front end surface 27a, which is a surface located on the front end 2a side of the second cutter body 21, and a second rear end surface 27b, which is a surface located on the rear end 2b side of the second cutter body 21. Each of the second front end surface 27a and the second rear end surface 27b may be a flat surface.

In the present specification, the description of “flat surface” or “plane” intends to mean that the surface is not a curved surface at a visible level or does not have unevenness at a visible level, and is not required to be strictly flat. The “flat surface” or “plane” may allow an unavoidable degree of unevenness that may occur in the manufacturing process, and specifically may have unevenness with a surface roughness of about 50 um.

The second cutter C20 may have a second pocket 26 located forward of the second cartridge 23 as the second cutting edge in the rotation direction T of the rotation axis L and connected to the second front end surface 27a. The second pocket 26 may be connected to the second rear end surface 27b. The second pocket 26 may have a second groove 40 located along the second cartridge 23 and extending from the front end 2a toward the rear end 2b.

The second groove 40 may be a surface extending from the front end 2a toward the rear end 2b so as to connect the second front end surface 27a and the second rear end surface 27b. The second groove 40 may be a surface corresponding to a side surface (a surface on the outer peripheral side) of the second cutter body 21, in other words, a surface corresponding to a side surface on the circumferential direction side of the second protruding portion 27. The second pocket 26 may be a space partially surrounded by the second groove 40.

The second groove 40 may be located along a second insert (second cutting edge) 23a and can be used as a chip discharge groove. If the second groove 40 is located along the second cutting edge, chips generated by the second cutting edge can be stably discharged to the outside.

The second cutter body 21 may have a center hole through which the base portion 4 can be inserted. The second cutter body 21 may have, for example, a plate shape. Specifically, the second cutter body may have a three-dimensional shape in which a plurality of second protruding portions 27 are formed by removing part of a disk-shaped object having an annular shape in a cross-sectional view taken in a direction orthogonal to the rotation axis L. In the present embodiment, the second cutter body 21 may have six second protruding portions 27 protruding in six directions in the view from the direction along the rotation axis L. The second cutter body 21 may have a shape of two-fold symmetry around the rotation axis L.

The second pocket 26 may be provided as a space penetrating from the front end 2a side to the rear end 2b side between two adjacent second protruding portions 27. The second pocket 26 may be a chip pocket through which the chips and coolant flowing from the front end 2a side toward the rear end 2b side pass. In the present embodiment, the second cutter C20 may have six second pockets 26. In the second cutter C20, a coolant ejection hole may not be formed in the second cutter body 21.

The second cutter C20 only needs to have a cutting edge (second cutting edge) whose edge tip protrudes from the outer peripheral surface of the second cutter body 21, and a specific aspect of the cutting edge located on the outer peripheral side is not particularly limited. In the present embodiment, one second cartridge 23 may be attached to the second pedestal portion 29 of each of the six second protruding portions 27 by a clamp screw or the like. As the second cartridge 23, a known cartridge can be used, and a specific aspect of the second cartridge 23 is not particularly limited.

A second insert (second cutting edge) 23a may be attached to the second cartridge 23 by a screw or the like. The second insert 23a is a so-called cutting insert. A specific aspect of the second insert 23a is not particularly limited. The position of at least one of the second cartridge 23 and the second insert 23a may be adjustable in the radial direction. Thus, a machining diameter by the second cutter C20 can be adjusted.

The second cutter C20 may be fixed to the shaft member 2 as follows. That is, the second cutter C20 may be fixed to the shaft member 2 by screwing the second rear end surface 27b and the flat surface 5a of the rear-side fixing portion 5 using a second fixture 28. In other words, the second cutter C20 may be fixed to the shaft member 2 by the second fixture 28 located closer to the rear end 2b side than the second cutter body 21. In the second cutter C20, part of the second rear end surface 27b may be in contact with the rear-side fixing portion 5.

The second cutter body 21 may be subjected to a lightening process for weight reduction or the like, and may have a plurality of recessed portions 27c formed in the second front end surface 27a. In addition, the second cutter body 21 may have a plurality of recessed portions 27d formed in the second rear end surface 27b. The recessed portion 27c and the recessed portion 27d may each have a rounded triangular shape in the view from the direction along the rotation axis L. The recessed portion 27c and the recessed portion 27d may be formed at positions corresponding to the front end 2a side and the rear end 2b side of the second protruding portion 27, respectively, in the plane perspective view from the front end 2a side toward the rear end 2b side. The recessed portion 27d is formed so as to avoid a region of the second rear end surface 27b to which the second fixture 28 is screwed.

### Third Cutter

The third cutter C30 may be located between the first cutter C10 and the second cutter C20 and fixed to the shaft member 2. The third cutter C30 may include a third cutter body 31 and a third cartridge 33 as a cutting edge (third cutting edge) located on the outer peripheral side.

The third cutter body 31 may have a third protruding portion 37 protruding in the radial direction. The third protruding portion 37 may have a third pedestal portion 39 to which the third cartridge 33 is attached at an end portion on the outer peripheral side. The third cutter C30 may have a third front end surface 37a, which is a surface located on the front end 2a side of the third cutter body 31, and a third rear end surface 37b, which is a surface located on the rear end 2b side of the third cutter body 31. Each of the third front end surface 37a and the third rear end surface 37b may be a flat surface.

The third cutter C30 may have a third pocket 36 located forward of the third cartridge 33 as the third cutting edge in the rotation direction T of the rotation axis L and connected to the third front end surface 37a. The third pocket 36 may be connected to the third rear end surface 37b. The third pocket 36 may have a third groove 60 located along the third cartridge 33 and extending from the front end 2a toward the rear end 2b.

The third groove 60 may be a surface extending from the front end 2a toward the rear end 2b so as to connect the third front end surface 37a and the third rear end surface 37b. The third groove 60 may be a surface corresponding to a side surface (surface on the outer peripheral side) of the third cutter body 31, in other words, a surface corresponding to a side surface on the circumferential direction side of the third protruding portion 37. The third pocket 36 may be a space partially surrounded by the third groove 60.

The third groove 60 may be located along a third insert (third cutting edge) 33a and can be used as a chip discharge groove. If the third groove 60 is located along the third cutting edge, chips generated by the third cutting edge can be stably discharged to the outside.

The third cutter body 31 may have a center hole through which the base portion 4 can be inserted. The third cutter body 31 may have, for example, a plate shape. Specifically, the third cutter body may have a three-dimensional shape in which a plurality of third protruding portions 37 are formed by removing part of a disk-shaped object having an annular shape in a cross-sectional view taken in a direction orthogonal to the rotation axis L. In the present embodiment, the third cutter body 31 may have six third protruding portions 37 protruding in six directions in the view from the direction along the rotation axis L. The third cutter body 31 may have a shape of two-fold symmetry around the rotation axis L.

The third pocket 36 may be provided as a space penetrating from the front end 2a side to the rear end 2b side between two adjacent third protruding portions 37. The third pocket 36 is a chip pocket through which the chips and coolant flowing from the front end 2a side toward the rear end 2b side pass. In the present embodiment, the third cutter C30 may have six third pockets 36.

The third cutter C30 only needs to have a cutting edge (third cutting edge) whose edge tip protrudes from the outer peripheral surface of the third cutter body 31, and a specific aspect of the cutting edge located on the outer peripheral side is not particularly limited. In the present embodiment, one third cartridge 33 may be attached to the third pedestal portion 39 of each of the six third protruding portions 37 by a clamp screw or the like. As the third cartridge 33, a known cartridge can be used, and a specific aspect of the third cartridge 33 is not particularly limited.

A third insert (third cutting edge) 33a may be attached to the third cartridge 33 by a screw or the like. The third insert 33a is a so-called cutting insert. A specific aspect of the third insert 33a is not particularly limited. The position of at least one of the third cartridge 33 and the third insert 33a may be adjustable in the radial direction. Thus, a machining diameter by the third cutter C30 can be adjusted.

The third protruding portion 37 may have a third outer peripheral surface 37c located rearward of the third pedestal portion 39 in the rotation direction T and located side by side with the third pedestal portion 39. The third outer peripheral surface 37c may be a surface located outward of the third pedestal portion 39 in the radial direction and formed at a position higher than the third pedestal portion 39 in the radial direction. A coolant ejection hole H31 may be formed in the third outer peripheral surface 37c. The ejection hole H31 may be located closer to the rear end 2b side than the third insert 33a.

Further, the third protruding portion 37 may have a third seating surface 37d located forward of the third pedestal portion 39 in the rotation direction T and located side by side with the third pedestal portion 39. The third seating surface 37d may be a surface formed at a height position equal to the third pedestal portion 39 in the radial direction. A coolant ejection hole H32 may be formed in the third seating surface 37d. The ejection hole H32 may be located forward of the third insert 33a of the third cartridge 33 in the rotation direction T and located adjacent to the third insert 33a.

In the third protruding portion 37, a coolant ejection hole H33 may be formed in the third rear end surface 37b at a position in the vicinity of the third outer peripheral surface 37c. The coolant ejected from the ejection holes H31 to H33 may flow toward the rear end 2b side.

In the third cutter C30, a coolant ejection hole H33 may be further formed in the third rear end surface 37b of the third cutter body 31. The ejection hole H33 may be formed in the third rear end surface 37b at a position in the vicinity of the third outer peripheral surface 37c. It may be formed at such a position that the coolant ejected from the ejection hole H33 flows toward the second cartridge 23 of the second cutter C20. The coolant ejected from the ejection holes H31 to H33 may flow toward the rear end 2b side.

The third cutter C30 may be fixed to the shaft member 2 as follows. That is, the third cutter C30 may be fixed to the shaft member 2 by screwing the third front end surface 37a and the flat surface 4a of the base portion 4 using a third fixture 38. In other words, the third cutter C30 may be fixed to the shaft member 2 by the third fixture 38 located closer to the front end 2a side than the third cutter body 31.

The third cutter body 31 may be subjected to a lightening process for weight reduction or the like, and may have a plurality of recessed portions 37e formed in the third front end surface 37a. The recessed portion 37e may have a rounded triangular shape in the view from the direction along the rotation axis L. The recessed portion 37e may be formed at a position corresponding to the front end 2a side of the third protruding portion 37 in the plane perspective view from the front end 2a side toward the rear end 2b side. The recessed portion 37e may be formed so as to avoid a region of the third front end surface 37a to which the third fixture 38 is screwed.

### Details of Respective Parts

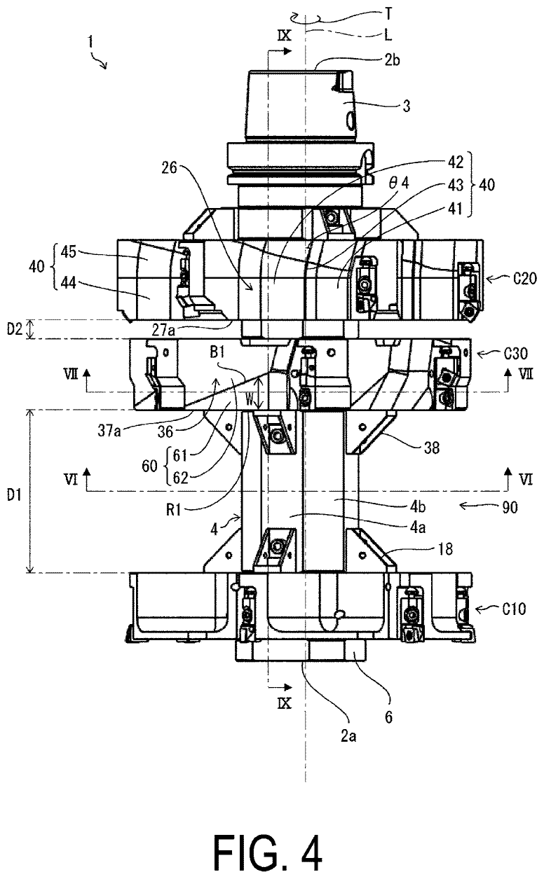

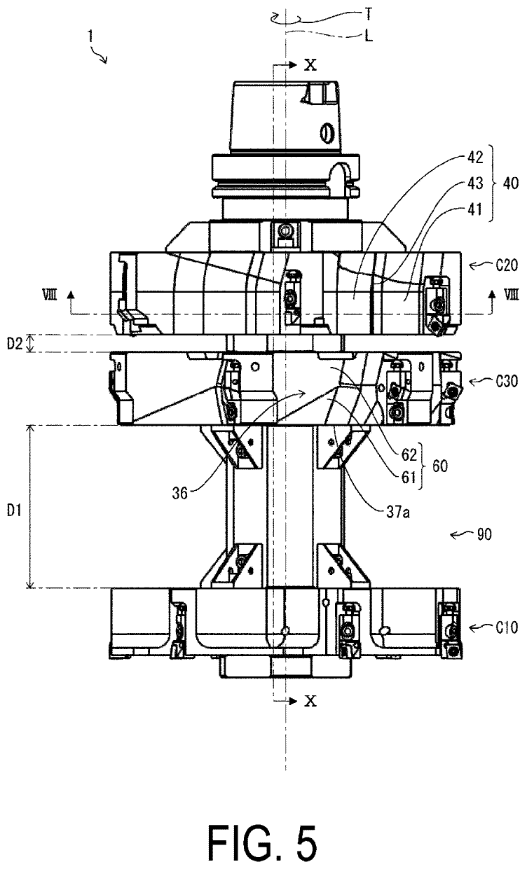

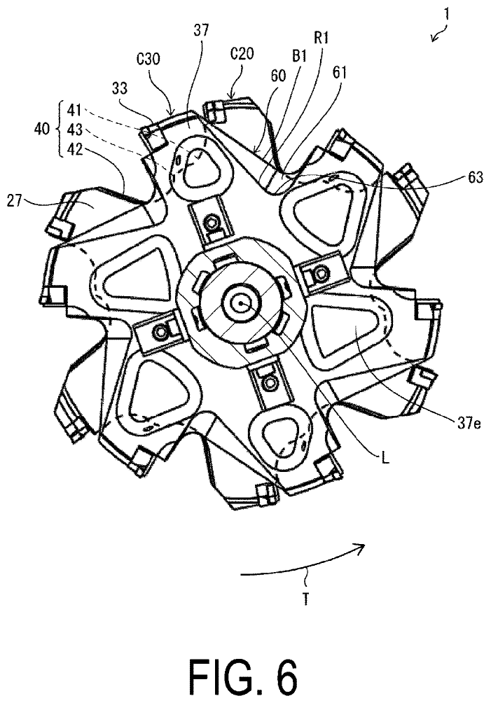

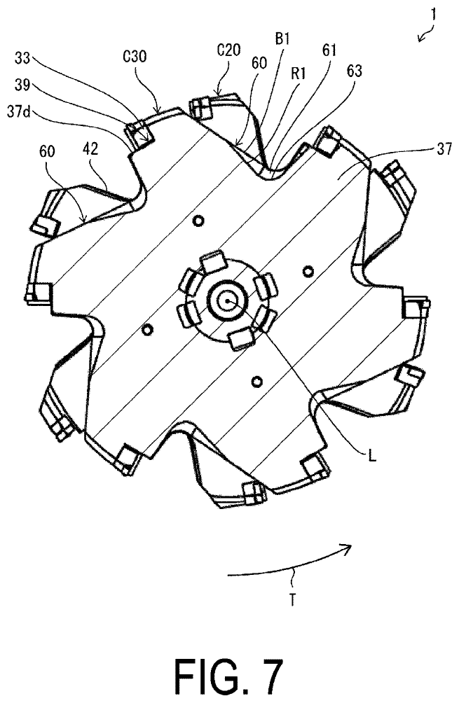

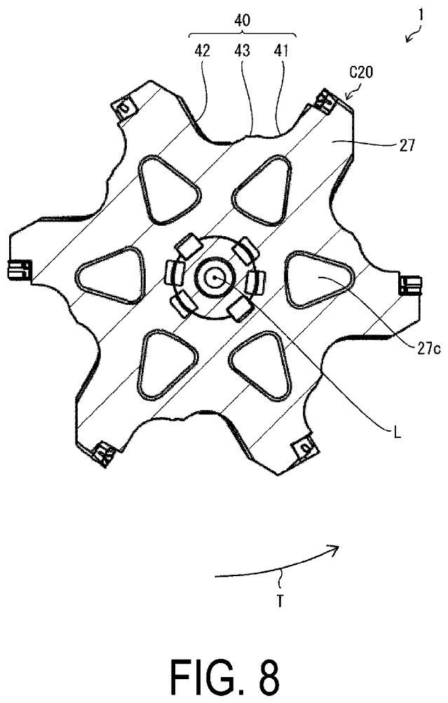

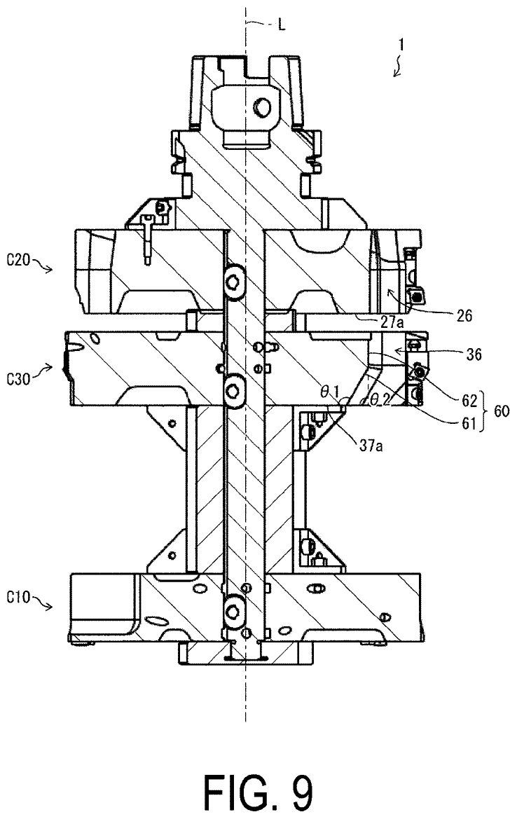

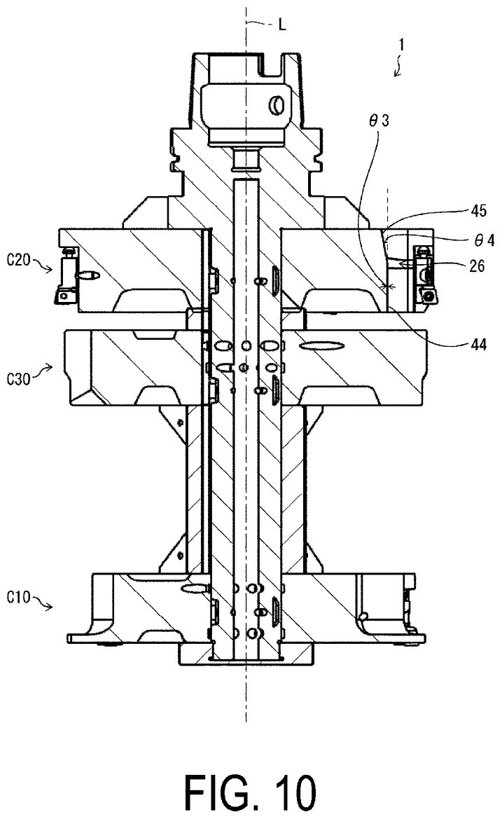

Hereinafter, the boring tool 1 according to the present embodiment will be described in more detail with reference to FIGS. 4 to 10. FIG. 4 is a side view of the boring tool 1 illustrated in FIG. 1 as viewed in an Al direction in FIG. 3. FIG. 5 is a side view of the boring tool 1 illustrated in FIG. 1 as viewed in an A2 direction in FIG. 3. FIG. 6 is a cross-sectional view taken along line VI-VI indicated by arrows in FIG. 4. FIG. 7 is a cross-sectional view taken along line VII-VII indicated by arrows in FIG. 4. FIG. 8 is a cross-sectional view taken along line VIII-VIII indicated by arrows in FIG. 5. FIG. 9 is a cross-sectional view taken along line IX-IX indicated by arrows in FIG. 4. FIG. 10 is a cross-sectional view taken along line X-X indicated by arrows in FIG. 5. In the following description, FIGS. 1 to 3 may also be referred to as appropriate.

As illustrated in FIGS. 4 to 10, in the boring tool 1 of the present embodiment, a distance D1 between the first cutter C10 and the third cutter C30 is larger than a distance D2 between the second cutter C20 and the third cutter C30. Depending on the application of the boring tool 1, such an arrangement of the cutter C may be required. It is also assumed to use a space between the first cutter C10 and the third cutter C30 as a coolant reservoir.

As described above, in the boring tool 1, the chips generated by the first cutter C10 on the front end 2a side flow toward the rear end 2b side, pass through the third cutter C30 and the second cutter C20, and are discharged to the outside.

In general, a boring tool having a plurality of cutters can increase machining efficiency. On the other hand, if the positions of the plurality of cutters are spaced apart from each other, it is difficult for chips to smoothly flow into the pocket of the cutter on the rear end side, and as a result, there is a concern that the cutter on the rear end side or the workpiece may be damaged.

Therefore, in the boring tool 1 of the present embodiment, the second pocket 26 may be connected to the second front end surface 27a at a right angle, and the third pocket 36 may be connected to the third front end surface 37a at an obtuse angle. It should be noted that the “right angle” in the above description is not limited to 90° in a strict sense and may be within a range of ±5°. Further, since the right angle is within a range of 90±5°, the “obtuse angle” is intended to be larger than 95°.

According to the above-described configuration, the coolant and the chips generated by the first cutter C10 can be caused to easily flow from a space 90 between the first cutter C10 and the third cutter C30 toward the third pocket 36, and to easily flow from the third pocket 36 toward the second pocket 26. Therefore, although the boring tool 1 has the plurality of cutters C, the chip discharge performance can be effectively improved.

In addition, in the boring tool 1 of the present embodiment, the third groove 60 extending from the front end 2a toward the rear end 2b while partially surrounding the third pocket 36 may include a third front region 61 located on the front end 2a side and connected to the third front end surface 37a and a third rear region 62 located closer to the rear end 2b side than the third front region 61. An inclination angle θ1 of the third front region 61 with respect to the third front end surface 37a may be larger than an inclination angle θ2 of the third rear region 62 with respect to the third front end surface 37a (see FIG. 9).

The inclination angle θ1 is an angle at which the third front region 61 is inclined with respect to the third front end surface 37a in a cross section (for example, the cross-sectional view illustrated in FIG. 9) obtained by cutting the boring tool 1 in a direction parallel to the rotation axis L and in a direction orthogonal to the protruding direction of one third protruding portion 37 (the normal direction of the flat surface 4a). The inclination angle θ1 is an obtuse angle and may be an angle of 120° or greater and 160° or less. The inclination angle θ2 is an angle at which the third rear region 62 is inclined with respect to the third front end surface 37a in the cross section (for example, in the cross-sectional view shown in FIG. 9). The inclination angle θ2 may be a right angle and may be within a range of 90±5°.

According to the above configuration, the chips generated by the first cutter C10 are easily drawn into the third pocket 36. In addition, if the inclination angle θ1 of the third front region 61 is larger than the inclination angle θ2 of the third rear region 62, the strength of the third protruding portion 37 of the third cutter C30 can be ensured and the chip discharge performance can be enhanced.

In the boring tool 1, a width W of a portion of the third front region 61 located forward of a bottom 63 of the third groove 60 in the rotation direction T may become narrower toward the front in the rotation direction T (see FIG. 4). The bottom of the third groove 60 is a portion of the third groove 60 located closest to the axis center side (radially inner side). The width W is defined by a distance in a direction parallel to the rotation axis L from a ridge line R1 at which the third front end surface 37a and the third front region 61 intersect each other to a boundary B1 between the third front region 61 and the third rear region 62, in a side view of the boring tool 1 (see FIGS. 4, 6, and 7).

According to the above-described configuration, in the third groove 60, the width W of the third front region 61 formed as a portion cut out closer to the axis center side than the third rear region 62 becomes smaller toward the third pedestal portion 39. Therefore, the third protruding portion 37 of the third cutter C30 can easily secure a volume in a portion on the rear side of the third pedestal portion 39 in the rotation direction T. As a result, the strength of the third protruding portion 37 can be easily ensured.

Further, in the present embodiment, the second groove 40 in the second cutter C20 extending from the front end 2a toward the rear end 2b while partially surrounding the second pocket 26 may include a first partial groove 41 and a second partial groove 42.

The first partial groove 41 may be a portion located along the second cartridge 23 (second cutting edge) and extending from the front end 2a side toward the rear end 2b side, and the second partial groove 42 may be located forward of the first partial groove 41 in the rotation direction T and extend from the front end 2a side toward the rear end 2b side. Each of the first partial groove 41 and the second partial groove 42 may be a curved surface having a shape recessed toward the second protruding portion 27 side in a cross section taken along a direction orthogonal to the rotation axis L.

The second groove 40 may have a ridge portion 43 that is an intersection of the first partial groove 41 and the second partial groove 42 and extends from the front end 2a side toward the rear end 2b side (see FIGS. 4, 5, 6, and 8). The ridge portion 43 may be a ridge line or a furrow portion having a certain width. In the boring tool 1, in a plane perspective view of the second cutter C20 and the third cutter C30 from the front end 2a side, the first partial groove 41 may be located rearward of the third cartridge 33 (third cutting edge) of the third cutter C30 in the rotation direction T (see FIG. 6).

According to the above-described configuration, the chips generated by the second cutter C20 can be caused to easily flow through a portion of the second pocket 26 where the first partial groove 41 is located, in other words, a portion of the second pocket 26 located on the rear end 2b side of the third protruding portion 37 in the above plane perspective.

In the present embodiment, in the plane perspective view of the second cutter C20 and the third cutter C30 from the front end 2a side, the second partial groove 42 may at least partially overlap the third groove 60 (see FIGS. 6 and 7).

According to the above-described configuration, the coolant and the chips generated by the third cutter C30 can be caused to easily flow from the third pocket 36 toward the rear end 2b side through a portion of the second pocket 26 where the second partial groove 42 is located. As described above, according to the boring tool 1 of the present embodiment, the second pocket 26 can be provided with a portion through which the chips generated by the second cutter C20 preferentially pass and a portion through which the chips generated by the third cutter C30 preferentially pass. Therefore, the chips can be caused to easily flow from the front end 2a side toward the rear end 2b side. As a result, the chip discharge performance can be enhanced.

For example, in the third cutter C30, the third front end surface 37a may be attached to the flat surface 4a of the base portion 4 by using the third fixture 38, and in the second cutter C20, the second rear end surface 27b may be attached to the flat surface 5a of the rear-side fixing portion 5 by using the second fixture 28. The flat surface 4a and the flat surface 5a may be offset from each other by 45° in the circumferential direction. Accordingly, the third protruding portion 37 and the second protruding portion 27 are offset from each other in the circumferential direction, and the third cutter C30 and the second cutter C20 can be fixed to the base portion 4. As a result, the flow of chips as described above can be generated in the second pocket 26. Further, by the arrangement of the coolant ejection holes H31 to H33 in the second cutter body 21 of the second cutter C20, the flow of the chips as described above can be more easily generated.

Further, in the present embodiment, the second groove 40 may have a second front region 44 located on the front end 2a side and a second rear region 45 located on the rear end 2b side. In a side view, an inclination angle of the second front region 44 with respect to the rotation axis L is defined as a first inclination angle θ3, and an inclination angle of the second rear region 45 with respect to the rotation axis L is defined as a second inclination angle θ4. In the boring tool 1, the second inclination angle θ4 may be larger than the first inclination angle θ3 (see FIGS. 4, 5, and 10). The first inclination angle θ3 may be substantially close to 0. The second inclination angle θ4 may be an angle ranging from 10° to 20°.

According to the above-described configuration, since the second rear region 45 is provided in the second pocket 26, the second pocket 26 can have a shape in which an area increases toward the rear end 2b side (the outlet side in the chip flow direction). Therefore, the chips flowing into the second pocket 26 can easily flow toward the rear end 2b side with respect to the second pocket 26 and be discharged to the outside. As a result, the chip discharge performance can be further improved.

In addition, in the second groove 40, the first inclination angle θ3 may be 0°, and the second front region 44 may extend parallel to the rotation axis L. This makes it easier for chips to flow from the third pocket 36 toward the second pocket 26.

### Material and the Like

Examples of the material of each part of the boring tool 1 include steel such as stainless steel, cast iron, and an aluminum alloy. In particular, in a case where steel is used among these materials, the toughness of the shaft member 2 is high. Examples of a material of the cutting edge such as the first insert 13a to the third insert 33a include cemented carbide alloy and cermet.

A composition of the cemented carbide alloy may include WC-Co, WC-TiC-Co, and WC-TiC-TaC-Co, for example. Here, WC, TiC and TaC may be hard particles, and Co may be a binding phase. The cermet may be a sintered composite material in which metal is composited with a ceramic component. Examples of the cermet may include titanium compounds in which one of titanium carbide (TiC) and titanium nitride (TiN) is a main component. The cutting edge used in the boring tool 1 is not limited to the above-mentioned material.

A size of the shaft member 2 is not particularly limited. For example, a length in a direction along the rotation axis L may be set to about from 150 mm to 300 mm. In addition, a diameter of the shaft member 2 corresponding to a thickness of the base portion 4 may be set to about 50 mm to 120 mm.

The machining diameter of each of the first cutter C10, the second cutter C20, and the third cutter C30 is not particularly limited. The machining diameter of the cutter C is defined by a diameter of a cutting circle of the edge tip of the cutter C. The machining diameter of the first cutter C10 may be smaller than the machining diameters of the second cutter C20 and the third cutter C30. The machining diameter of the third cutter C30 may be larger than the machining diameter of the first cutter C10 and smaller than the machining diameter of the second cutter C20. For example, the machining diameter of the first cutter C10 may be set to about 60 mm to 280 mm. For example, the machining diameter of the second cutter C20 may be set to about 160 mm to 280 mm. For example, the machining diameter of the third cutter C30 may be set to about 140 mm to 280 mm.

The distance D1 between the first cutter C10 and the third cutter C30 may be about 60 mm to 150 mm. The distance D2 between the second cutter C20 and the third cutter C30 may be about 10 mm to 80 mm.

Variations Without being limited to the example of the present embodiment, the boring tool 1 may have four or more cutters C. For example, a fourth cutter may be provided between the first cutter C10 and the third cutter C30.

Without being limited to the example of the present embodiment, each of the first cutter C10, the second cutter C20, and the third cutter C30 may be formed integrally with the shaft member 2 so as to be continuous with the shaft member 2.

The cutting edges of the first cutter C10, the second cutter C20, and the third cutter C30 may be formed integrally with the first cutter body 11, the second cutter body 21, and the third cutter body 31, respectively.

Without being limited to the example of the present embodiment, each of the first cutter C10 and the third cutter C30 may be screwed to the curved surface 4b of the base portion 4. The second cutter C20 may be screwed to the curved surface 5b of the rear-side fixing portion 5. A specific means for fixing the first cutter C10, the second cutter C20, and the third cutter C30 to the shaft member 2 is not particularly limited, and a specific shape of the shaft member 2 is not particularly limited.

Method for Manufacturing Machined Product A method for manufacturing a machined product according to one non-limiting aspect of the present disclosure will be described with reference to FIGS. 11 to 14. FIGS. 11 to 14 are schematic views illustrating one step of a method for manufacturing the machined product. For clarity of illustration, the workpiece WP is shown in a cross section while the boring tool 1 is shown in a side view.

A machined product may be produced by carrying out machining on the workpiece WP. The method for manufacturing a machined product according to the embodiment includes the following steps. Specifically,
(1) rotating the boring tool 1,
(2) bringing the boring tool 1 into contact with the workpiece WP, and
(3) separating the boring tool 1 from the workpiece WP are included.

More specifically, firstly, as illustrated in FIG. 11, while the boring tool 1 may be caused to rotate around the rotation axis L, the boring tool 1 may be brought relatively close to the cylindrical workpiece WP. For example, the boring tool 1 may be rotated by connecting the connecting portion 3 of the boring tool 1 to a spindle or the like.

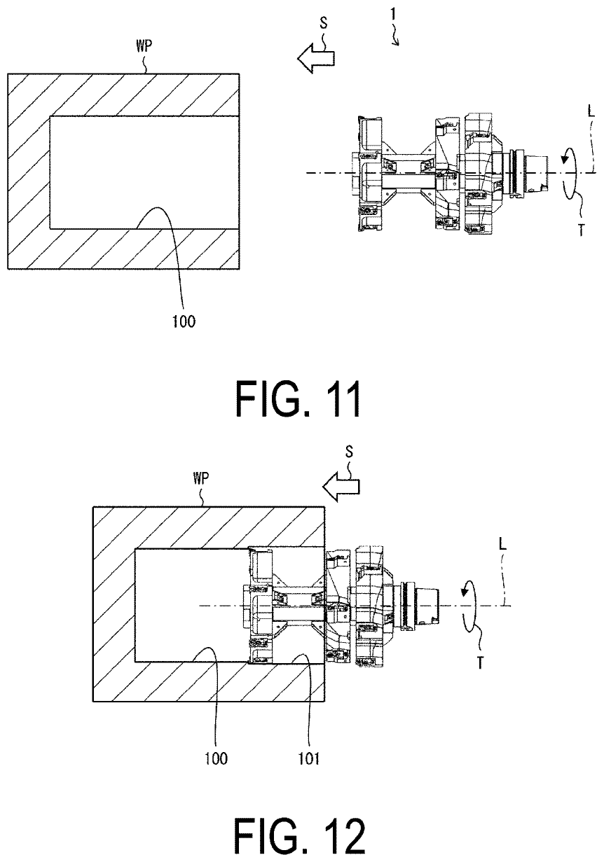

Next, as illustrated in FIG. 12, the cutting edge of the first cutter C10 of the boring tool 1 is may be brought into contact with the inner peripheral surface of the workpiece WP to cut the inner peripheral surface 100 of the workpiece WP, thereby performing inner diameter machining of enlarging the inner diameter of the workpiece WP. As a result, it is possible to form a first machined region 101 machined by the first cutter C10 and having a larger inner diameter than that of the inner peripheral surface 100 of the workpiece WP.

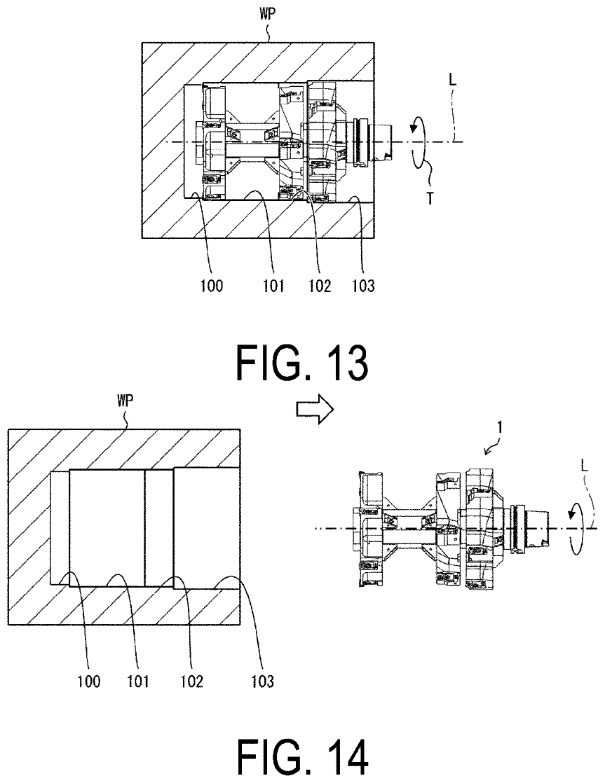

Next, as illustrated in FIGS. 12 and 13, the boring tool 1 may be further advanced into the workpiece WP. Thus, the cutting edge of the third cutter C30 can be brought into contact with the first machined region 101 to form a third machined region 102 machined by the third cutter C30 and having a larger inner diameter than that of the first machined region 101. Then, the cutting edge of the second cutter C20 can be brought into contact with the third machined region 102 to form a second machined region 103 machined by the second cutter C20 and having a larger inner diameter than that of the third machined region 102.

Thereafter, as illustrated in FIG. 14, the boring tool 1 may be relatively moved away from the workpiece WP.

In the example of FIGS. 11 to 13, the boring tool 1 is moved in the state in which the workpiece WP is fixed and the boring tool is rotated around the rotation axis L, and accordingly the boring tool is brought close to the workpiece WP. In addition, in the example of FIGS. 11 to 13, the workpiece WP is cut by bringing the cutting edge of the boring tool 1 that is rotating into contact with the workpiece WP fixed. Additionally, in FIG. 14, the boring tool 1 is moved while the workpiece WP is fixed, and accordingly the boring tool 1 is moved away from the workpiece WP.

In the method for manufacturing according to the present embodiment, the boring tool 1 is brought into contact with the workpiece WP or the boring tool 1 is moved away from the workpiece WP by moving the boring tool 1 in each step. However, naturally, the present invention is not limited to such a configuration.

For example, in step (1), the workpiece WP may be brought close to the boring tool 1. Similarly, in step (3), the workpiece WP may be moved away from the boring tool 1. Further, the present invention is not necessarily limited to the above example, and the workpiece WP may be rotated. When the boring tool 1 rotates relative to the workpiece WP, the workpiece WP can be machined.

Representative examples of the material of the workpiece WP may include hardened steel, carbon steel, alloy steel, stainless steel, cast iron, non-ferrous metals, or the like.

### Supplementary Note

In the present disclosure, the invention has been described above based on the various drawings and embodiments. However, the invention according to the present disclosure is not limited to each embodiment described above. That is, the embodiments of the invention according to the present disclosure can be modified in various ways within the scope illustrated in the present disclosure, and embodiments obtainable by appropriately combining the technical means disclosed in different embodiments are also included in the technical scope of the invention according to the present disclosure. In other words, a person skilled in the art can easily make various variations or modifications based on the present disclosure.

Note that these variations or modifications are included within the scope of the present disclosure.

1. A boring tool comprising:
a shaft member extending along a rotation axis from a front end toward a rear end;
a first cutter located on a side at which the front end is provided, and fixed to the shaft member;
a second cutter located on a side at which the rear end is provided, and fixed to the shaft member; and
a third cutter located between the first cutter and the second cutter, and fixed to the shaft member,
wherein a distance between the first cutter and the third cutter is greater than a distance between the second cutter and the third cutter,
the second cutter comprises:
a second front end surface that is flat and located on the side at which the front end is provided;
a second cutting edge located on an outer peripheral side; and
a second pocket
located forward of the second cutting edge in a rotation direction of the rotation axis, and
connected to the second front end surface,
the third cutter comprises:
a third front end surface that is flat and located on the side at which the front end is provided;
a third cutting edge located on the outer peripheral side; and
a third pocket
located forward of the third cutting edge in the rotation direction, and
connected to the third front end surface, and
the second pocket is connected to the second front end surface at a right angle, and the third pocket is connected to the third front end surface at an obtuse angle.

2. The boring tool according to claim 1, wherein
the third pocket comprises a third groove
located along the third cutting edge, and
extending from the side at which the front end is provided toward the side at which the rear end is provided,
the third groove comprises:
a third front region located on the side at which the front end is provided, and connected to the third front end surface; and
a third rear region located closer to the side at which the rear end is provided than the third front region, and
an inclination angle of the third front region with respect to the third front end surface is larger than an inclination angle of the third rear region with respect to the third front end surface.

3. The boring tool according to claim 2, wherein a width of a portion of the third front region located forward of a bottom of the third groove in the rotation direction becomes narrower toward the front in the rotation direction.

4. The boring tool according to claim 1, wherein
the second pocket comprises a second groove
located along the second cutting edge, and
extending from the side at which the front end is disposed toward the side at which the rear end is disposed,
the third pocket comprises a third groove
located along the third cutting edge, and
extending from the side at which the front end is disposed toward the side at which the rear end is disposed,
the second groove comprises:
a first partial groove
located along the second cutting edge, and extending from the side at which the front end is disposed toward the side at which the rear end is disposed;
a second partial groove
located forward of the first partial groove in the rotation direction, and
extending from the side at which the front end is disposed toward the side at which the rear end is disposed; and
a ridge portion that is an intersection of the first partial groove and the second partial groove, and extends from the side at which the front end is disposed toward the side at which the rear end is disposed, and
the first partial groove is located rearward of the third cutting edge in the rotation direction in a plane perspective view of the second cutter and the third cutter from the side at which the front end is disposed.

5. The boring tool according to claim 4, wherein the second partial groove overlaps the third groove in the plane perspective view of the second cutter and the third cutter from the side at which the front end is disposed.

6. The boring tool according to claim 5, wherein
the second pocket comprises a second groove
located along the second cutting edge, and
extending from the side at which the front end is disposed toward the side at which the rear end is disposed,
the second groove comprises:
a second front region located on the side at which the front end is disposed; and
a second rear region located on the side at which the rear end is disposed, in a side view,
an inclination angle of the second front region with respect to the rotation axis is a first inclination angle, and
an inclination angle of the second rear region with respect to the rotation axis is a second inclination angle, and
the second inclination angle is larger than the first inclination angle.

7. The boring tool according to claim 6, wherein the first inclination angle is 0°, and the second front region extends parallel to the rotation axis.

8. A method for manufacturing a machined product, the method comprising the steps of:
rotating the boring tool according to claim 1;
bringing the boring tool into contact with a workpiece; and
separating the boring tool from the workpiece.
